(19) United States
(12) Patent Application Publication
(10) Pub. No.: US 2004/0180107 A1
(43) Pub. Date: Sep. 16, 2004

(54) Mould for plastics items

(76) Inventor: Zeno Zuffa, Borgo Tossignano (IT)

Correspondence Address: COLLARD & ROE, P.C., 1077 Northern Boulevard, Roslyn, NY, 11576-1696, US

(21) Appl. No.: 10/389,179

(22) Filed: Mar. 14, 2003

(51) Int. Cl. B29C 45/43; B29C 45/44

(52) U.S. Cl. 425/437; 425/438; 425/DIG. 58

(57) ABSTRACT

A mould for moulding plastics items formed by two half-moulds movable between a closing position and an opening position, said closing position defining a cavity (24) for forming the plastic item and said opening position allowing the removal of the moulded item, apertures (23) being arranged in the surface (25, 26) of the forming cavity (24) of one half-mould (1), said apertures (23) communicating with the source (41) of compressed air when said mould is open, in such a way to prevent the formation of a vacuum between said item and said surface from being generated and cause detachment of said item from said surface (25, 26).

The present invention concerns a mould for moulding plastic items provided with a device to make removal of the moulded items easier.

Particularly, but not exclusively, an object of the invention is to improve removing of hollow items such as stoppers, caps, closures from the moulds in moulding of plastic material. The prior art comprises a mould for plastic material, comprising two half-moulds, one of which is shaped as a cavity and the other one is shaped as a punch which is received in the cavity, an hollow space being defined between the cavity and the punch in which a predetermined amount of plastic material is poured.

The cavity and the punch are so shaped as to give a final shape to the moulded item. In particular, when a screw cap is to be produced, the cavity defines the outer shape of the cap, whilst the punch defines the inner shape of the cap, which is provided with a screw thread.

Because of the screw thread, or other undercuts with various shape, when the mould is opened, the moulded item remains initially attached to the punch, from which it is subsequently removed in by means of a suitable extractor and exploiting the elasticity of the material, which is still in a flexible state when the item is removed.

It has been observed that, when the mould is opened, air encounters a certain difficulty to penetrate between the outer surface of the moulded item and the surface of the forming cavity, because of the tendency of the plastic material to adhere to the surface of the cavity.

In fact, a vacuum is generated between the cavity and the surface of the item which tends to hold the item in the cavity and causes the punch to exert tensile stresses on the item.

In consequence of this, certain dimensions of the item may be altered and detrimental deformation of the internal screw thread can occur.

An object of the present invention is to improve a mould for moulding plastic items, providing it with a device that, when the mould is opened, avoids the generation of a vacuum, so as to prevent damaging the moulded item.

A further object of the present invention is to obtain an improved mould, in which removal of the moulded item from the forming cavity is made easier.

According to the invention, there is provided a mould for moulding items in plastic material, the mould being formed by mould parts movable between a closed position, that define a forming cavity for forming the item, and an open position, in which the moulded item can be removed from the mould, wherein apertures are arranged at a surface of a forming cavity of one of the mould parts, said apertures being linkable, when opening the mould, with a source of compressed air, in such a way as to prevent a vacuum between said item and said surface from being generated and cause detachment of said moulded item from said surface.

Further features of the invention will better appear from the following detailed description of an embodiment thereof, illustrated with non limitative purpose in the following drawing, in which:

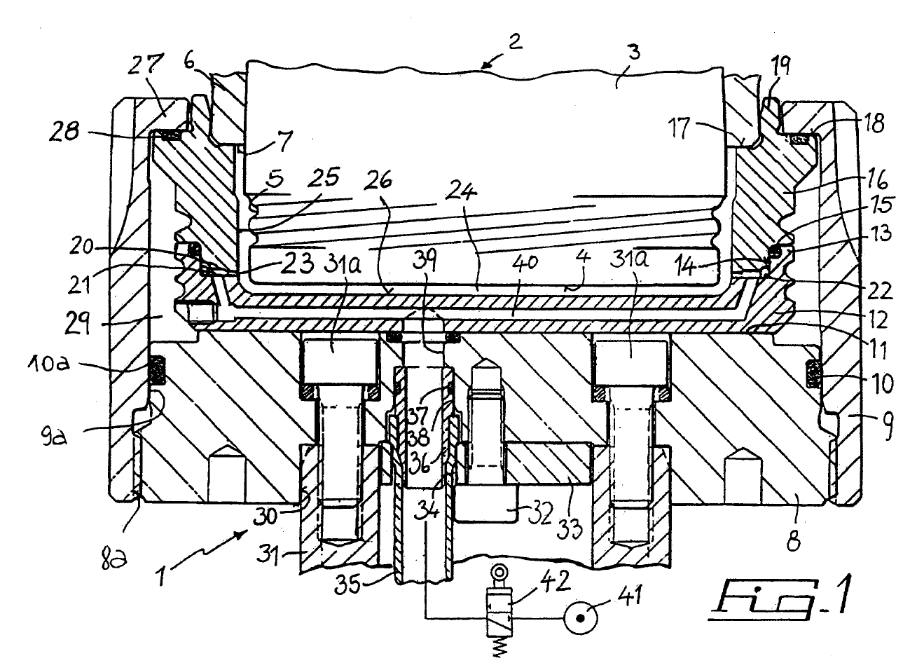

FIG. 1 is a longitudinal section of an improved mould for moulding a screw cap for closing containers;

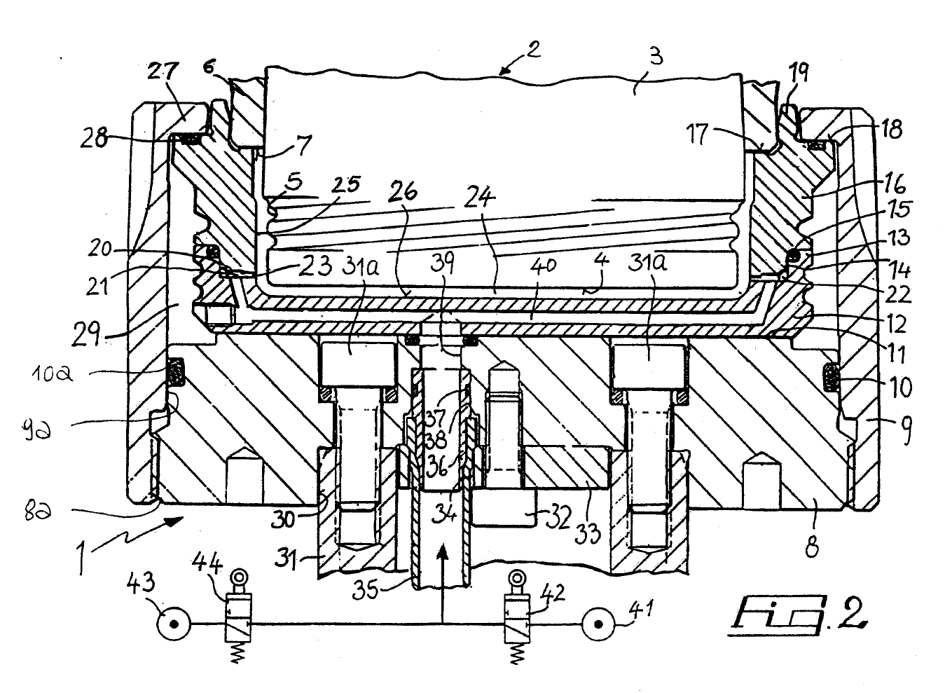

FIG. 2 shows a longitudinal section of a first version of the mould;

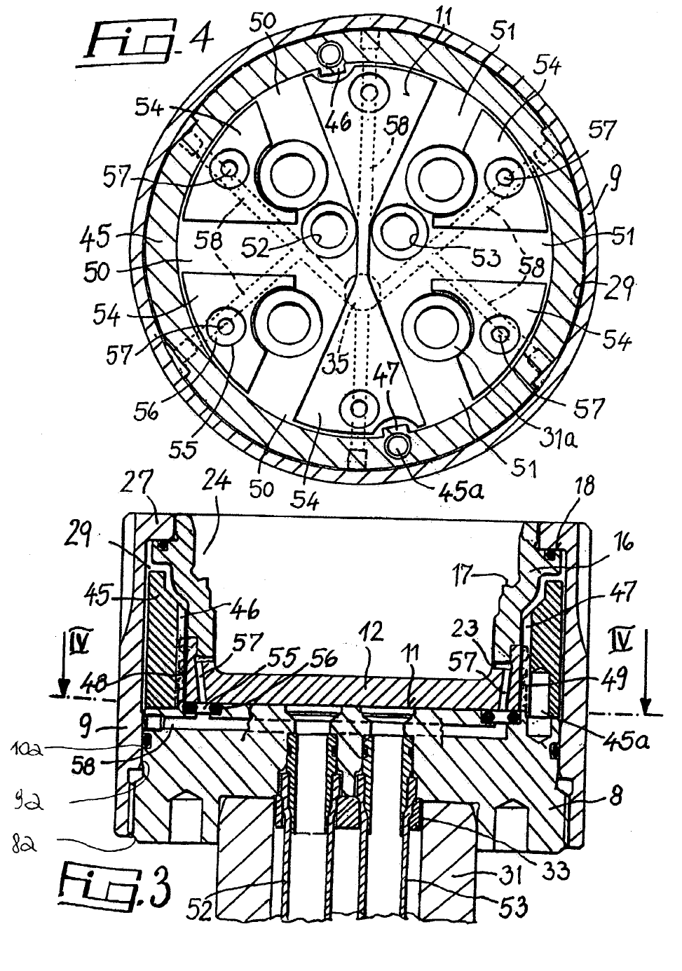

FIG. 3 shows a longitudinal section of a second version of the mould and

FIG. 4 shows a section taken along plane IV-IV of FIG. 3.

With reference to the FIG. 1, the mould comprises a first mould part with 1, and an second mould part 2.

The second mould part 2 is substantially formed by a cylindrically shaped punch 3 comprising a plane frontal face 4 and a peripheral groove 5, the peripheral groove 5 extending helically around the punch 3 in an annular area close to an edge of the punch 3 defined by the frontal face 4.

On the punch 3, there is provided a collar 6 slidably mounted between a first position, shown in FIG. 1, in which a front edge 7 of the collar 6 is distanced apart from the groove 5, and a second position in which the collar 6 is nearer to the groove 5.

The first mould part 1 comprises a disk-like body 8 having an outer thread 8a on which a ring nut 9 is screwed. A seal ring 10, housed in a suitable annular recess 10a of the disk-like body 8, is interposed between an inner wall of the ring nut 9 and a centering wall 9a of the ring nut 9 which serves to center the disk-like body 8.

The disk-like body 8 is provided with a flat surface 11 on which rests a bottom plate 12 having a peripheral edge 13, which is distanced apart from the bottom plate to define an annular seat 14 in which a ring 16 is centered, a seal ring 15 being interposed between said annular seat 14 and the peripheral edge 13.

Two coaxial flat regions 17, 18, between which an annular projection 19 is located, are provided at an outer end of the ring 16.

The ring 16 has a bas 20 which is received into the seat 14 and rests on a flat zone 21, defining the seat 14 together with the peripheral edge 13 of the bottom plate 12.

The base 20 is provided with an outer edge so worked as to define with the seat 14 an annular channel 22 from which a plurality of angularly spaced passageways extends radially crossing a corresponding end portion of the base 20.

The passageways provide apertures 23 leading into a forming cavity 24, which is defined between an inner cylindrical surface of the ring 16 and an outer surface 26 of the bottom plate 12.

The ring nut 9 is provided, at its end far from the other end screwed on the thread 8a, with an inner lip 27 which engages the flat regions 18, thus engaging also a sealing gasket 28 interposed therebetween.

By screwing the ring nut 9 on the disk-like body 8, the bottom plate 12 and the ring 16 are firmly blocked against the surface 11 of the disk-like body 8. The ring nut 9, the ring 16, the bottom plate 12, and the disk-like body 8, define an annular chamber 29 which is linked with two channels, a delivery channel and a return channel, not shown in FIGS. 1 and 2, for delivering to, and returning from, the mould a cooling liquid.

The delivery channel and the return channel will be later described in connection with FIGS. 3 and 4.

In an outer part of the disk-like body 8, a housing 30 is defined in which an end of a tubular column 31 is mounted through screws 31a, the screws 31a passing through the disk-like body 8 and being screwed in threaded holes obtained in the thickness of the tubular column.

An inner plate 33, having an eccentric hole 34 is fixed, by means of a bolt 32, in a central region of the housing 30 and is surrounded by the tubular column 31.

The eccentric hole 34 receives a pipe 35 passing therethrough, the pipe 35 receiving a connection bush 36 which has an end portion inserted into a seat 38 obtained in the disk-like body 8, a seal ring being interposed therebetween.

The seat 38 communicates, by means of a hole 39 crossing the disk-like body 8 and the bottom plate 12, with a plurality of channels 40 having a substantially radial configuration and located in the thickness of the bottom plate 12.

The channels 40 communicate with the annular channel 22 and, through the apertures 23, with the cavity 24 of the first mould part 1.

The pipe 35 communicates with a source of compressed air 41 through a non return valve 42.

Working the described mould during the moulding phase does not differ from the traditional operation method.

When the mould is open, namely the punch 3 is spaced from the first mould part 1, a preset quantity of plastic material is poured in the cavity 24. When the punch 1 is moved towards the first mould part 1, the preset quantity of plastic material is compressed until it fill the operative volume defined, in the cavity 24, by the surfaces of the punch 3, of the ring 16 and of the bottom plate 12; after that, the operative volume is closed when the front edge 7 rests on the shoulder 17. It is observed that said operative volume has the same shape as the cap.

When the plastic material has reached a certain degree of solidification that assures shape stability of the moulded item, and just before opening the mould, compressed air is injected in the cavity 24.

The compressed air flows through the pipe 35, the hole 39 and the channels 40, and flows out from the apertures 23 and thus penetrates between the wall of the cavity 24 and the moulded item, the compressed air avoiding the formation of a depressurised zone that, when the punch is moved away from the lower half-mould 1, could have had negative effects on the cap. The moulded item is detached from the wall of the cavity but is held by the thread of the punch 2.

In a subsequent phase the moulded item is expelled from the punch by means of the axial thrust exerted by the collar 6 on the item, which occurs with no damage being caused on the item because of the elasticity of the plastic material which is not completely solidified.

Advantageously, a portion of the pneumatic circuit, extending between the apertures 23 and the on-off valve 42, has a certain pneumatic capacity that, acting as a plenum chamber, allow pressure stabilization during the moulding phase.

FIG. 2 shows a version of the invention in which evacuation of the forming cavity 24 is obtained by providing connection of the pipe 35, in parallel with the delivery of the compressed air, with an inlet source 43 through an on-off valve 44.

In this version, just before closing the mould and before injection of the compressed air, the valve 44 is commutated so as to connect the inlet source 43 with little pipe 35 and then with the cavity 24. Evacuation of air from the cavity 24 continues while the material is moulded.

By evacuating all of the air from the cavity 24, a considerable advantage is achieved, that air cannot be entrapped in the cavity, which could cause defective moulding of the caps.

Before opening the mould, the valve 44 is commutated again in the closing position and the valve 42 is commutated so as to connect the source 41 of compressed air with the cavity 24 through the pipe 35 for completing removal of the cap from the mould.

The FIGS. 3 and 4 show a further version of the invention, in which the annular chamber 29 is provided with a cylindrical wall 45 which is centered and fixed on the disk-like body 8 by means of pins 45a.

The cylindrical wall 45 is internally provided with two diametrically opposing axial ribs 46, 47, which engage corresponding recesses 48, 49 in the bottom plate 12 and in the ring 16.

The ribs 46, 47 divide the chamber 29 into two parts connected with two corresponding terns of grooves 50, 51 that are provided in the surface 11 of the disk-like body 8 and are closed on their external part by the bottom plate 12. The grooves 50, 51 converge towards two channels 52 and 53 respectively for delivering and returning a cooling liquid.

The grooves 50, 51 divide the surface 11 of the disk-like body 8 in a plurality of angular sectors 54 in correspondence of which are formed annular seats 55 housing toroidal gasket 56. The seats 55 connect, through holes 57 obtained in the bottom plate 12, the apertures 23 with corresponding channels 58 which are formed in the disk-like body 8 and are connected with the pipe 35 in which the compressed air and inlet air flow.

The embodiment of FIGS. 3, 4, allows a greater simplification in manufacturing the mould, whilst the ring 45, because of the ribs 46, 47, assures an effective stirring of the cooling liquid, and thus an uniform cooling of the lower mould 1 and of the moulded item.

It has to be observed that the inventive idea can be applied not only to pressure moulding, but also to injection moulding.

1. Mould for moulding items in plastic material comprising a first mould part and a second mould part which are movable between a closing position and an open position, said closing position defining a cavity for forming a plastic item and said open position being suitable for allowing removal of the moulded item, apertures being arranged in a surface of the forming cavity of said first mould part, said apertures communicating, when the mould is open, with a source (41) of compressed air, so as to prevent a vacuum between said item and said surface from being generated, and cause detachment of said moulded item from said surface.

2. Mould for moulding hollow items in plastic material, in particular stoppers, caps, and the like, comprising a first mould part provided with a cavity and a punch, said first mould part and said punch being movable between a closing position and an open position, said punch defining, into said closing position a forming cavity in which said item is formed, apertures being are arranged in a surface of said cavity, said apertures being communicating, when the mould is open, with a source of compressed air, so as to prevent a vacuum between the moulded item and said surface from being generated and cause detachment of said moulded item from said surface.

3. Mould according to claim 2, wherein said first mould part, comprises a bottom plate on which a ring is centered, said bottom plate and said ring defining said cavity, between said bottom plate and said ring said apertures being provided.

4. Mould according to claim 3, wherein said bottom plate is positioned on a disk-like body on which is screwed a ring nut which is provided with an annular inner lip and is suitable for clamping said ring and said bottom plate on said disk-like body.

5. Mould according to claim 4, wherein in said bottom plate channels are defined, said channels being connected, on one side, with said apertures and, on the other side, with said source of compressed air.

6. Mould according to claim 4, wherein in that disk-like body channels are provided obtained, said channels being connected, on one side, with said apertures through holes of said bottom plate and, on the other side, with said source of compressed air.

7. Mould according to claim 4, wherein said ring nut defines with said ring and with said bottom plate an annular chamber connected with, respectively, a cooling liquid delivering pipe and a cooling liquid return pipe.

8. Mould according to claim 7, wherein grooves are provided on said disk-like body, said grooves being closed by said bottom plate, some of said groves connecting said annular chamber with said delivering pipe, and some other of said grooves connecting said annular chamber with said return pipe.

9. Mould according to claim 8, wherein an arrangement for stirring the cooling liquid is housed into said annular chamber (29).

10. Mould according to claim 9, wherein said arrangement comprises a cylindrical wall provided with two axial diametrically opposing ribs, which engage corresponding recesses of said bottom plate and of said ring, said ribs dividing said annular chamber into two parts connected with two groups of grooves closed by said bottom plate, the grooves of one group converging into the cooling liquid delivering pipe, and the grooves of the other group converging into the cooling liquid return pipe.

11. Mould according to any one of claims 2 to 10, wherein said apertures are connected to said source of compressed air by means of a valve.

12. Mould according to any one of the claims 2 to 10, wherein said apertures are connectable with an inlet source by an intercept valve.

13. Mould for moulding plastic items provided with a device for facilitating the removal of the moulded items according to which is from the description and from the attached drawings.
